(19) United States
(12) Patent Application Publication
(10) Pub. No.: US 2024/0337127 A1
(43) Pub. Date: Oct. 10, 2024

(54) ELECTROMAGNETIC POOL RELATED PLATFORM BATTERY CHARGING

(71) Applicant: Maytronics Ltd., Kibutz Yizrael (IL)

(72) Inventors: Ron Guy, Kibbutz Kfar-Ruppin (IL); Shay Witelson, Kibbutz Yizrael (IL)

(73) Assignee: Maytronics Ltd., Kibutz Yizrael (IL)

(21) Appl. No.: 18/681,857

(22) PCT Filed: Aug. 8, 2022
(86) PCT No.: PCT/IB2022/057388

§ 371 Date: Feb. 6, 2024

Related U.S. Application Data
(60) Provisional application No. 63/260,059, filed on Aug. 6, 2021.

(51) Int. Cl. E04H 4/16; H02J 50/10; H02J 50/80

(52) U.S. Cl. CPC E04H 4/1654; H02J 50/10; H02J 50/80

(57) ABSTRACT

A method for charging a pool related platform (PRP), the method may include (i) positioning a first wireless charging element (WCE) of the PRP within a charging range of a second WCE of a charging unit that is movable and is located at a temporary PRP location that is outside an interior of a pool structural element; wherein the positioning comprises moving the first WCE towards the PRP location; and (ii) wirelessly charging, by the second WCE, the first WCE while maintaining the first WCE within the charging range of the second WCE.

### CROSS REFERENCE

This application claims priority from U.S. provisional patent 63/260,059 filing date 6 Aug. 2021 which is incorporated herein by reference in its entirety.

### FIELD OF INVENTION

The present invention relates to systems and methods for providing electromagnetic connections (EMC) to charge pool related platforms (PRPs) such as but not limited to pool cleaning robots (PCRs) operating in swimming pools, with focus on solutions for Above Ground Pools (AGP).

### BACKGROUND

It is well known that swimming pools are differentiated by two main groups of pools: In-Ground Pools (IGP) that may require complex underground and substantial engineering construction and, on the other side, AGP that vary in sizes and complexity that may allow an end user to install such a pool in his yard by DIY means.

Although this specification focuses on AGP, the specification herein may apply to any type of pool whether AGP or IGP.

PCR are fast becoming a common feature in all types of pools, including in AGP but mainly in IGP. It is of major interest to end users to provide PCR to all types of swimming pools to the benefit of swimming pool owners.

It is also well known that PCR are usually connected and powered by means of electrical cables that receive their power from external electrical power supplies that are located on the pool deck or at some distance from the pool's edge.

Such cables may be regarded as physical or aesthetical obstacles in any swimming pool environment but maybe less so in AGP where the cable of the submerged PCR is placed or settled on the AGP rim to be able to reach the external power supply pack.

The PCR industry has been developing battery operated PCR solutions and there is growing demand for such PCR because there is a growing need to reduce human effort in the operations of cleaning pools and also for aesthetical reasons. There is also growing need to use non-cabled pool robots that may be battery operated.

In response to such market demand, developments have concentrated on solutions how to charge on-board PCR batteries.

One way of achieving this is to employ an underwater, contactless EMC power supply connections, such as an inductive electrical charging system that comprises two half-core coil winding assemblies, where at least one such half coil may be fully submerged underwater.

For ease, the primary first half-core coil winding assembly (or sub-assemblies thereof or second wireless charging element (WCE)) may be referred to hereinafter as a transmitter or a TX; and the secondary half-core coil winding assembly (or sub-assemblies thereof or second WCE) may be referred to as a receiver or a RX. Effectively, this is a special type of a plug-and-socket configuration.

Usually, such electrical inductive powering or charging systems need to be pre-engineered to be embedded in a pool wall or in a pool surface. Namely, the TX is in contact with the volume of pool water, so that the PCR RX or any of its relevant RX components may physically come into contact with the TX to have any electrical power transfer or battery charging performed.

A simple and elegant solution is to locate an inductive transmitter unit (TX) behind a pool wall or any pool surface which may also comply with all, if not most, electrical strict pool safety regulations.

It is easier and cost effective to isolate an inductive TX from any wet or moist environments to the benefit of swimming pool users.

The PCR includes an on-board receiver unit (RX) that approaches the said TX. As soon as a viable connection has taken place, battery charging procedure may commence. Such procedure may be fully automatic after multiple post PCR cleaning cycles or initiated manually by, for example, remote control devices.

It is clear that the direct inductive charging system has an advantage over the indirect one because the barrier of the skin or pool wall surface in itself and the increased distances between the first transmitting winding to the second receiving winding may provide a lower electrical power that may be necessary to power larger underwater electrical equipment.

### SUMMARY

There may be provided herein devices, systems and methods for providing non-contact electromagnetic connection devices allowing power transmission for underwater PCR battery charging in any type of swimming pool.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a pool cleaning robot with exemplary external TX mounted embodiments in a pool according to embodiments of the invention;

FIG. 2 illustrates a side and a front view of a pool cleaning robot with an RX according to an embodiment of the invention;

FIG. 3 illustrates a removeable TX according to an embodiment of the invention;

FIG. 4 illustrates a side cross section view of a pool cleaning robot according to an embodiment of the invention;

FIG. 5 illustrates a view of an external floor mounted TX according to an embodiment of the invention;

FIG. 6 depicts a Pool cleaning RX charging at an external pool TX;

FIG. 7 depicts an external adjustable and removable pocket mounted removeable TX;

FIG. 8 depicts a removeable and adjustable box mounted TX;

FIG. 9 depicts a removable and adjustable box mounted TX charging a pool cleaning robot;

FIG. 10 is an example of a method; and

FIG. 11 is an example of a pool related platform and other elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Any reference in the specification to a device or a system should be applied mutatis mutandis to a method that can be executed by the device or the system.

Because the illustrated or depicted embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that can be executed by the system and should be applied mutatis mutandis to a non-transitory computer readable medium that stores instructions that once executed by a computer result in the execution of the method.

There is provided a cordless, battery powered pool cleaning robot (PCR) that charges its batteries while being attached or pressed against a wall of a swimming pool to connect to an external TX.

There is provided a cordless, battery powered pool cleaning robot (PCR) that charges its batteries while being positioned on a floor of a swimming pool to connect to an external TX.

The specification specifically concerns a PCR that operates within the submerged part in the pool that may use an external to the pool battery charger (TX) that is positioned externally to the water submerged side of the pool walls or floor that comprise the pool structure.

Externally may also include locating and affixing a TX in between layers or plies of the wall or floor structures.

In an IG pool, the TX may be positioned and affixed in-between a pool structure (concrete, steel, fiber glass) and a liner that is added to provide the final pool covering usually made of PVC sheeting.

Affixing a TX behind a ceramic tile may also provide an appropriate solution.

By using inductive power transfer from outside the submerged section of a pool to the PCR inside the pool provides a simple, easy and safe environment for PCR battery charging without the need of removing the PCR or its battery for external charging after every cleaning cycle.

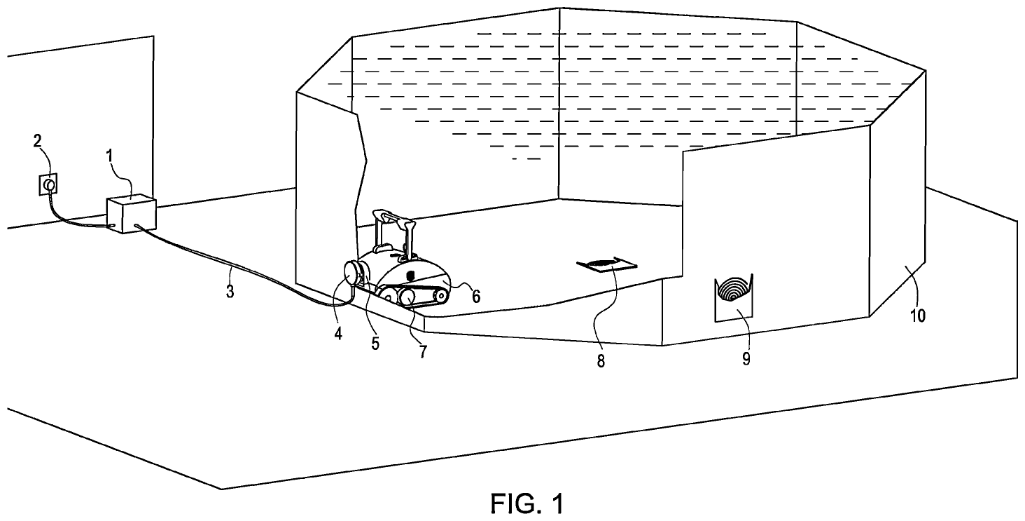

FIG. 1 depicts an electrical power supply charger (1) that may be connected a mains electricity supply inlet (2). A cable wiring conduit (3) extends the distance to connect to a removable TX (4) that is attached onto the external side of a pool wall. In this instance an AGP structure is depicted. A PCR (6) that is submerged inside of the pool, is depicted as connected by means of the PCR RX (5)—at its front end—through the pool wall structure (10), in order to charge the PCR batteries.

The TX may be bound onto the pool wall by either attaching it and positioning it in-between the plies of a layered PVC foil or liner or ceramic tiles (9). The TX may alternatively or additionally be positioned or incorporated into the plies or any layered structure or ceramic tiles of the pool floor (8).

An important aspect of this invention is that the incorporation and integration of the said TX mechanisms onto a prefabricated pool wall section(s) (9) and/or a prefabricated pool floor layer may be best achieved by the OEM pool manufacturers or builders.

Typically, such an OEM prefabrication may have the TX pre-sewn into the wall or floor surface.

The OEM or in-situ pool builder or assembler incorporation and integration of TX (8) and/or TX (9) in FIGS. 1 and 5, may alternatively be externally attached onto an external side of wall (10) or underneath a floor by any means to secure its location and attachment. Such positioning, attachments and electrical TX connection, may be performed by an end user purchasing the said TX assembly as a part of his swimming pool, purchasing the TX as part of his PCR model, or in an after sales as a separate add-on kit provided that the said end user already has or will have a suitable battery operated PCR.

Typically, such attachments may employ, for example, double sided Velcro DIY strips or other solutions described further-on

TX (8) and/or TX (9) in FIGS. 1 and 5 may both be removable to be relocated to other locations anywhere in the pool area.

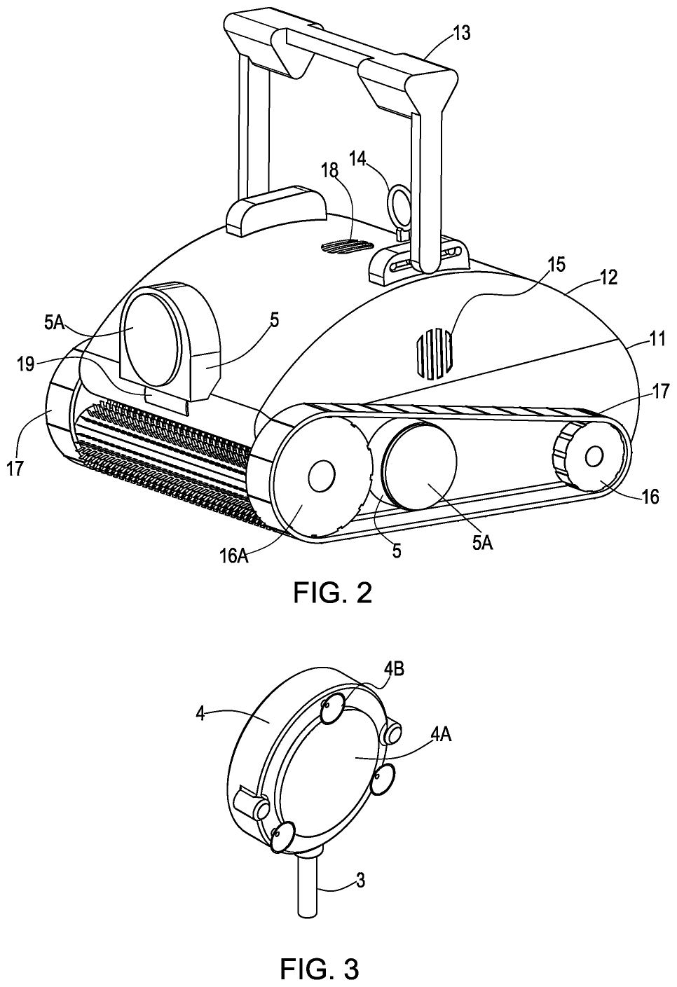

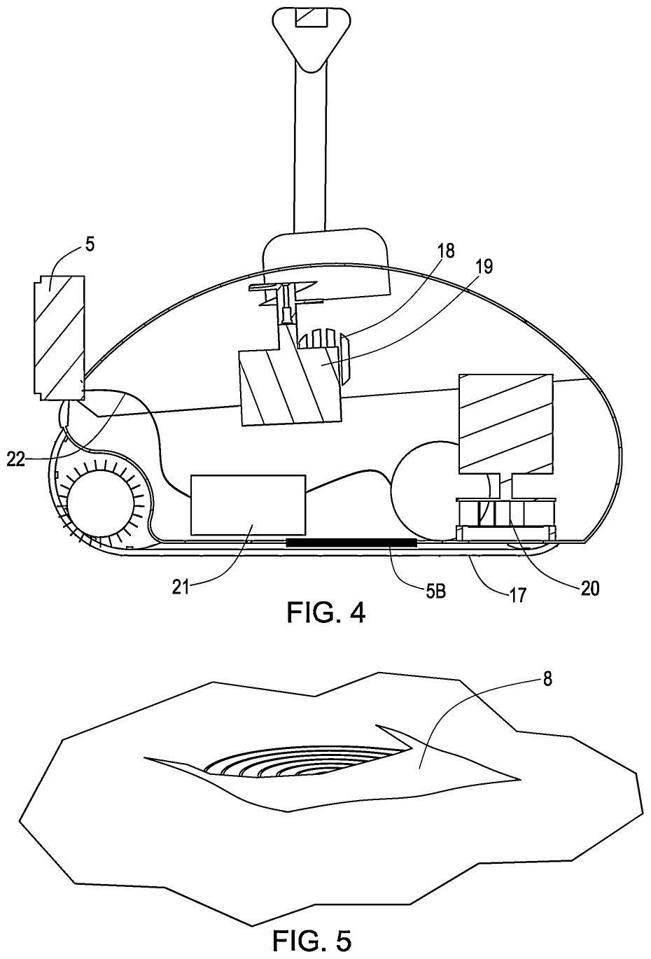

FIG. 2 depicts a PCR close up having it RX (5) at the front of the PCR housing (11). Also depicted is an alternative positioning of the RX on the side of the housing (5A) for a side charging maneuver connection to the wall TX. Floor charging RX positioning is depicted in FIG. 4 (5B). PCR impact bumpers for gentle and soft contacts between the PCR and the pool wall surfaces may be provided (not shown)

The PCR in FIG. 2 includes an openable or removeable top cover (12) to access or remove a filtering system located inside the hollow housing of the PCR. Water jet outlet (15) is also shown that may be an exemplary jet outlet of additional navigational jet outlets that are not shown here. Also depicted are wheels 16, 16A to roll and propagate the PCR around the pool. Similar wheels 16 C and 16D on the other side of the PCR are not shown. Tracks (17) are shown along with at least one rotational cleaning brush (18). A ring (14) to retrieve the PCR is also provided. A pool pole (regular or telescopic) with a suitable hook attachment may be used for the PCR retrieval. Alternatively, in shallow waters, where the PCR is manually accessible, the user may grip the handle (13) to retract the PCR out of the water.

The RX assembly (5) includes an internal secondary inductive ferrite coil with the front facia (5A) of the RX having a substantially flat surface to engage a similar configuration TX front facia located on the outside of the pool wall.

Wireless two-way data transmission is provided between the Rx and the Tx for data sent from the pool cleaning robot to the Rx and/or the Tx, to the power supply and to a user or a user that may be able to receive and send wireless messages by means of a computerized device.

It should be noted that the removable TX in this specification are preferably located at the lower end of the pool walls at varying height distances from the pool floor such as for example: 5-10 cm, 15-20 cm, 25 cm, 30 cm and so on.

Built-in or OEM factory fitted or integrated TX may also be positioned at similar heights from the pool floor, with or without end user positioning adjustment possibilities.

The floor TX (8) embodiment remains substantially horizontal and parallel to the floor surface on the external floor side or in between layer(s) or plies of the pool floor.

The said RX (5) depicted in FIG. 2, may slightly protrude from the contours of the PCR housing (11) to allow for positive contact with a TX. It also further includes an adjustable RX height positioning mechanism (19) to allow the RX assembly (5) to be linearly moved by upwards or downwards extraction to be aligned to the external TX. Namely, the end user may reset the RX position vertically (up, down) and/or at a tilt angle in order to have best RX and TX inductive facia-to-facia surfaces matching fittings.

The said RX height positioning mechanism (19) may be built of a rigid and sturdy construction yet a flexible built providing a push-back feature of the RX. This feature protects the surrounding pool surfaces from continual contacts that the PCR may have with walls during its cycle time. Yet, when the RX approaches the TX for charging connection, the said flexibility—or push-back feature—will allow for a soft, snug squeezing-in contact between the RX and the pool wall where the TX is located.

The built and construction of the RX (5, 5A) will therefor include a substantially soft—yet slippery—front rim arrangement to avoid unnecessary rubbing against pool surfaces.

FIG. 3 depicts a removeable TX assembly (4) that includes a primary inductive ferrite coil with a front facia (4A) of the TX having a substantially flat surface facia (4A) to engage a similar configuration RX (5A) containing a secondary inductive ferrite coil that is attached onto the PCR that is submerged underwater inside the pool.

The TX in FIG. 3 depicts exemplary suction cups (4B) attachment means of the TX onto an external side of the pool wall. Any other means that allow the TX to be removably attached to the pool wall without damaging the pool construction may be used. An embodiment of the said removability feature will be discussed further-on.

For any TX positioning or location in this specification, both the RX and the TX have a mutual positioning or location confirmation using an electronic sensing device such as ultrasonic beam or a magnetic resonance allowing for a return signal from the TX to the RX and to the main control PCB located inside the PCR. More than one sensor may be used so that the matching of TX and RX electrical inductive facias are fully aligned. Compass/gyrocompass, magnetometer, pool mapping techniques and a SLAM navigation program may be used to define the travel trajectory of the PCR in the pool. Means for correcting said RX and TX alignments are provided for in this specification.

PCR and RX may reduce speed and gently approach the TX for charging or data transfers, so that to reduce any unnecessary impacts against the TX or the pool walls. It is provided for a PCR and RX approach towards the TX while gently squeezing-in the RX facia circumference onto alignment with the TX facia circumference. Repositioning and realignments are provided for, whereas the PCR may move back to correct its trajectory and to reconnect again.

In another embodiment the end user may program and transmit the TX location to the RX and onto the PCR control logic by means of wireless communications such as a smartphone, tablet and the like. This makes it handy if the end user chooses to remove or reposition the location of his removable TX, in the pool, and wants to update the TX position.

The said communication function includes, in FIG. 1, a wireless electronic message transmitting, such as from a handheld (or desktop) RCU, to the power supply charger (1). The transmitting may include directional movement commands, or a cleaning parameter may be sent by a user, this is in turn relays the data captured via cable (3) onto TX (4) which emits, by means of inductive data transfer—along with inductive electrical power, a constant or intermittent data signal onto the PCR and the RX assembly on-board while the PCR is travelling in the pool.

Data transfer may be a two-way process: commands may be sent wirelessly (or via wire) from the end user to the PCR such as for example: electronic control logic software updates, modifying cycle times or cycle modes (clean floor only, climb walls, clean waterline etc.), weekly or periodical automatic start-end timer settings.

The PCR may transmit status data back to the end user. For example: filter cleanliness status, battery status, charging statues (such as “charging started” or “complete”), PCR error reports (stoppages), cycles data and cycle time data, water conditions (temperatures, water chemistry), recommended servicing removal from the pool and the like.

Any such two-way messaging may be routed to or from the internet or a cloud-based platform using standard mobile cellular technology, Wi-Fi® or Bluetooth® and data transfers are meant to be predominantly accomplished during the battery charging process or generally, when the RX and the TX are connected.

For battery charging to start, the PCR may measure its dwindling battery capacity and automatically travel for recharge. This allows for multiple charging without human interventions. At least one LED light may be activated in the TX when charging is in process.

There is also provided a LED indication light on any of the removeable Tx alternatives in this specification for status while charging or post charging (e.g.: red and green LEDS). Such an indication will provide the end user information about positive charging contact of both the TX and the RX without necessitating adjustments of the TX position.

Likewise, the pool wall/floor surfaces integrated TX (8) or (9) are also wired and electrically supplied (3) by the said connected power supply charger (1) and/or an alternative solar power supply sub-system external to the pool (not shown).

FIG. 4 depicts internal on-board components that are located inside the hollow PCR housing space (11) such as, water inlet (17), at least one water outlet (18), at least one pump motor and impeller (19), at least one drive motor (20), a filtering unit in the hydraulic path between inlet and outlet(s) (not shown), a rechargeable battery (21), a bottom located RX for floor charging (5B) and electrical and data wiring conduits connecting the RX to the battery, motors and electronics control (not shown).

FIG. 5 is a cut through depiction of an exemplary hidden underfloor positioned TX (8) that can be attached externally onto the outer layer of the pool floor or in between the fabric layers or plies. The wall mounted TX (9) of FIG. 1 may be of similar configuration. Both TX may be geometrically round or of any other shape such, as square or rectangular and the likes.

Importantly, TX (8 and/or 9) may be removable by a user and re-attached by any suitable means. For example, TX (9) may contain scotch tape type strips to position or to reposition the TX as required. This may also be easily achieved by simple end user DIY means.

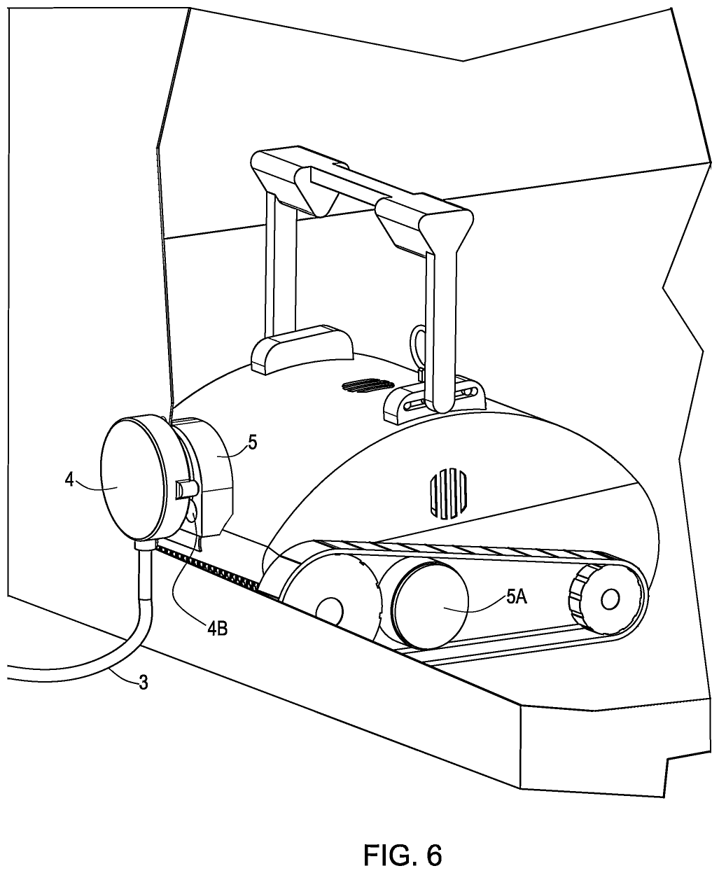

FIG. 6 depicts a charging contact of the PCR RX with the TX. That positioning may be good also for a rear charging (not shown). For a side charging (5A), the TX may be positioned slightly lower by the end user.

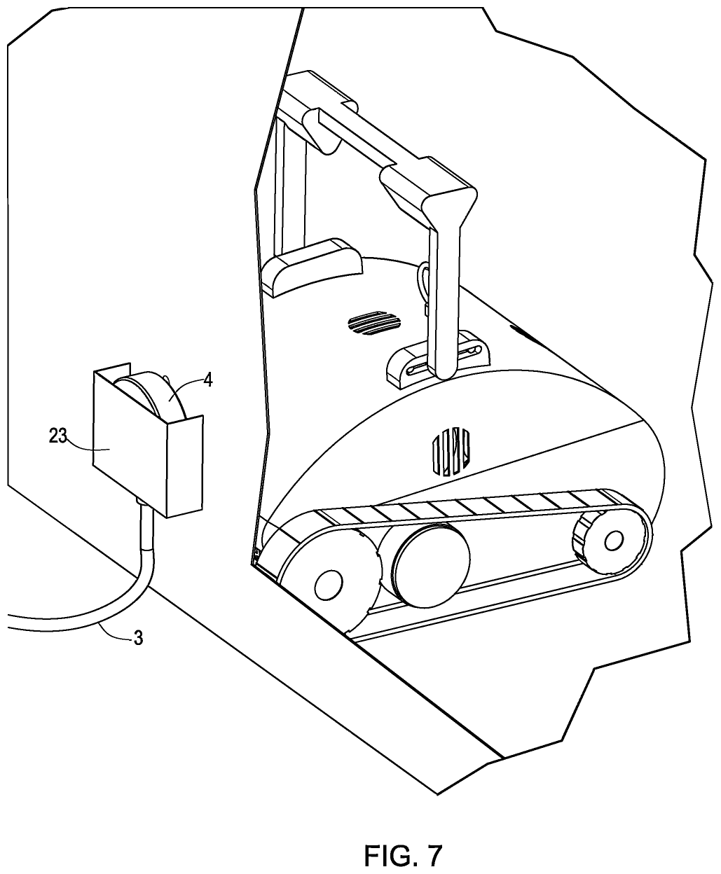

FIG. 7 depicts an embodiment for a removable TX (4 or 9) holding pocket (23) that may be permanently attached onto the external pool wall (by the pool OEM) or be removable (by the user), by similar means mentioned in this specification, for positioning, repositioning, adjustment or relocations—as required. The holding pocket may be configured to have a TX securing or gripping means inside the pocket, a top closing sleeve to protect the TX (4) from dust or water spluttering and a bottom opening for the cable exit (3) leading to external power supply (1 and 2).

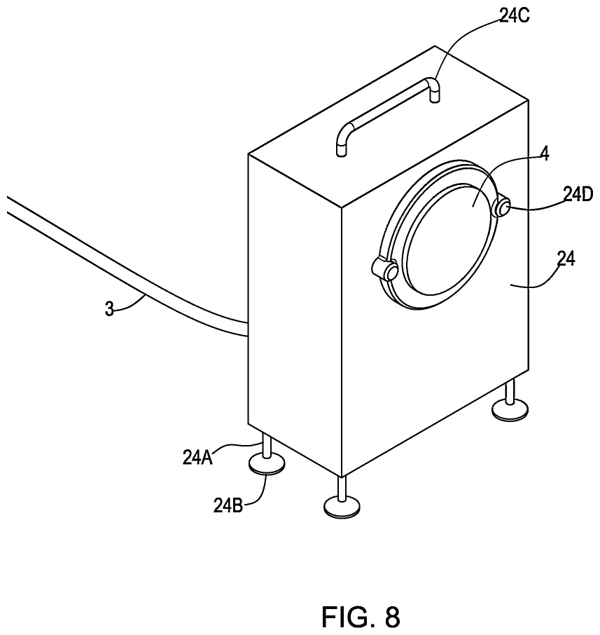

FIG. 8 depicts a standalone removeable TX housing (24) containing a TX (4) with electrical connection (3) that may be placed in contact to the external pool wall side. In order to ensure a snug TX and RX connection, the TX may be telescopically adjusted height/lengthwise, adjusted outwardly (towards the pool external wall). The TX (24D) may also provide for a lateral and vertical distance and angle extension/retraction (24D) from the TX housing towards the pool wall (up, down, back and forth and angled) to provide a optimal TX and RX surfaces connection.

Depicted are 4 legs (24A) but this configuration may alternatively include a tripod device with flexible octopus type legs that may be bent and aligned to multiple positions.

A TX housing (24) carrying handle (24C) is provided along with threaded housing vertical height adjustable axle legs or feet (24A) to manually align and adjust (upwards or downwards) the TX positioning to that of the RX. A wooden, polymer or rust-free metal surface or ground cone shaped leveler supports (24B) may also be provided whereby the supports may be removably attached to the bottom of each axle/leg so that the said leveler support(s) may be temporarily removed should the end user need to position, fasten or secure the said TX housing (24) to solid harder surfaces or onto non-level softer surfaces (such as grass lawn) that may surround the external swimming pool walls contour base. The TX housing may also be supplied in after sale kit form.

Such adjustable leg supports (24A) may also include foot grips provide increased stability whilst the rear legs may be flexible to allow extension for further adjustable adherence to the external pool wall surface.

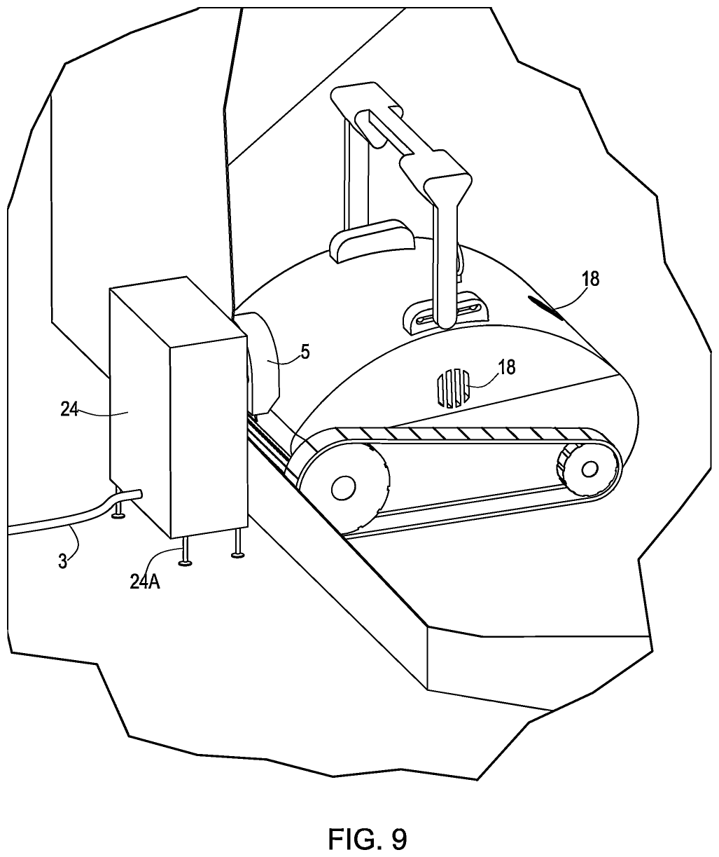

FIG. 9 depicts the TX housing in contact with the pool wall and the PCR RX while charging the PCR batteries.

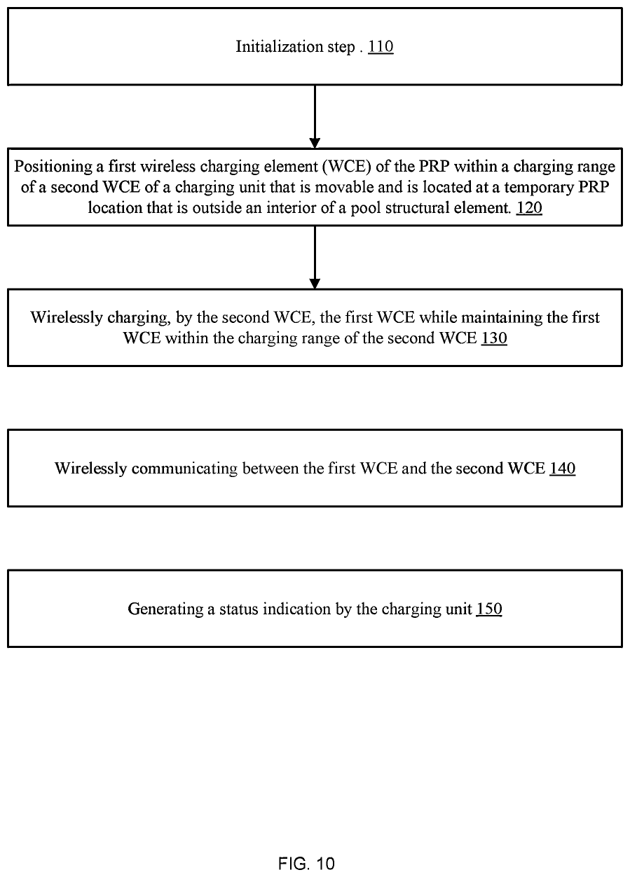

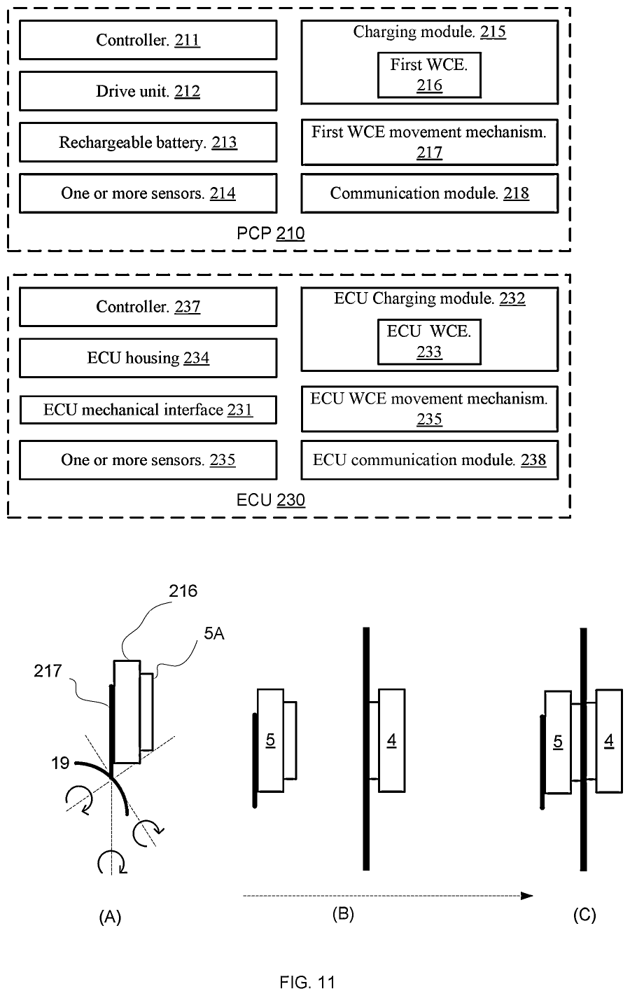

FIG. 10 illustrates an example of method 100 for charging a pool related platform (PRP).

The PRP may be any platform that may perform an operation related to a fluid of a pool—cleaning, changing chemical composition, monitoring, and the like. Examples of a PRP include a pool robot that differs from a PCR, a PCR, a floating unit, a skimmer, and the like. Any example related a PCR may be applied mutatis mutandis, to any other PRP.

Method 100 may start by initialization step 110.

Initialization step 110 may be followed by step 120 of positioning a first wireless charging element (WCE) of the PRP within a charging range of a second WCE of a charging unit that is movable and is located at a temporary PRP location that is outside an interior of a pool structural element.

Step 120 may include moving the first WCE towards the PRP location.

A charging range is a range in which wireless charging can occur. The charging range may be defined as a range in which an effective wireless charging can occur. Effective may mean that at least a predefined percent (for example at least 50 percent) the charging energy is not lost during the propagation between the first WCE and the second WCE.

Because the wireless charging is made through a pool structural element such as a sidewall, one or more layers or portions of the sidewall, a bottom of the pool, one or more layers or portions of the bottom—the charging range may be relatively small- and may be, for example be of less than 1, 2, 3 centimeters and the like.

Step 120 may include (a) moving the PRP towards the PRP location, and (b) moving the first WCE in relation to another part of the PRP.

Step (b) may include pushing the first WCE against an interior of the pool structural element. The pushing or pressing may reducing the distance between the first WCE and the second WCE.

Step 120 may include moving the first WCE based on an indication of the temporary PRP location.

The indication may be wirelessly transmitted temporary PRP location information (“location information”) that provides an explicit indication of the PRP location.

The location information may be sent to the PRP during initialization step 110 and/or during step 120.

The indication of the temporary PRP location is wirelessly transmitted radiation that is transmitted from the charging unit. For example—the charging unit may transmit beacon signals from one or more beacons.

Step 120 may include aligning the first WCE with the second WCE. The aligning may occur, during step (b) or following step (b).

The method according to claim 7 wherein the aligning is a sensor-based aligning that comprises using readings of one or more alignment sensors.

Step 120 may be followed by step 130 of wirelessly charging, by the second WCE, the first WCE while maintaining the first WCE within the charging range of the second WCE.

The charging may stop when a predefined condition (for example a certain charging level of the replaceable battery is reached) is fulfilled—and the PDP may move away from the charging unit.

Method 100 may also include step 140 of wirelessly communicating between the first WCE and the second WCE.

Method 100 may also include step 150 of generating a status indication by the charging unit. For example—by wireless communication aimed to a user device, by light emitting diodes, and the like.

The charging unit is detachably coupled to the pool structural element during the wirelessly charging. The detachable coupling may occur during initialization step 110.

Steps 120 and 130 may be executed whole the charging unit is detachably coupled, by suction caps, to the pool structural element during the wirelessly charging.

Steps 120 and 130 may be executed while charging unit is detachably coupled, by hook & loop fasteners to the pool structural element during the wirelessly charging.

Steps 120 and 130 may be executed while charging unit is positioned within a holder element that is connected to the pool structural element during the wirelessly charging.

Steps 120 and 130 may be executed while the second WCE is positioned, at least in part, within a stand-alone holder element.

Steps 120 and 130 may be executed while the second WCE is positioned, at least in part, within a stand-alone holder element that comprises adjustable legs.

Steps 120 and 130 may be executed while the second while the second WCE is pushed against the pool structural element.

FIG. 11 is an example of a pool related platform (PRP) 210 that may include a controller 211, a drive unit 212, a rechargeable battery 213, one or more sensors 214 (for example navigation sensors, alignment sensors), and a charging module 215 that includes a first wireless charging element (WCE) 216. An example of a PRP is a PCR such as the PCR illustrated in any one of FIGS. 1-7 and 9.

The controller 211 is configured to control the drive unit 212 to move the PRP to maintain the first WCE within a charging range of a second WCE of a charging unit that is movable and is located at a temporary PRP location that is outside an interior of a pool structural element. The first WCE is configured to be wirelessly charged, by the second WCE, while the first WCE is maintained within the charging range of the second WCE.

The PRP may include a first WCE movement mechanism 217 that is configured to move the first WCE in relation to another part of the PRP. The first WCE movement mechanism may include, for example, adjustable RX height positioning mechanism (denoted 19 in FIG. 2).

The first WCE movement mechanism 217 may include any mechanical elements (for example—motors, gears, rods, mechanical transfer units, and the like) for moving the first WCE. The movement may include linear movement and/or rotational movements along any axis.

The first WCE movement mechanism may be configured to push the first WCE against an interior of the pool structural element.

The first WCE movement mechanism may be configured to push the first WCE based on an indication of the temporary PRP location.

The first WCE movement mechanism may be configured to align the first WCE with the second WCE.

The PRP may include one or more alignment sensors and wherein an alignment of the first WCE with the second WCE is a sensor-based alignment.

The controller may be configured to control the drive unit to move towards the temporary PRP location based on an indication of the temporary PRP location

The PRP may include a communication module that is in communication with the first WCE, wherein the communication module is configured to communicate, via the first WCE, with the second WCE.

The first WCE may be located in any location—outside the PRP, partially outside the PRP, fully outside the PRP. For example—the first WCE faces a bottom of a housing of the PRP. Faces—may include that an imaginary line that extends from the bottom of the first WCE intersects the bottom. The first WCE may be parallel to a sidewall of the PRP.

FIG. 11 also illustrates various example of movements of the first WCE by the first WCE movement mechanism, a charging position in which the first WCE is aligned with the second WCE, and the like.

FIG. 11 also illustrates an example of an external charging unit (ECU) 230 that may include an ECU mechanical interface 231, an ECU charging module 232 that includes an ECU wireless charging element (WCE) 233, an ECU housing 234, one or more ECU sensors (for example proximity sensors and/or alignment sensors) 235, an ECU WCE movement mechanism 236 that is configured to move the ECU WCE in relation to another part of the PRP, a controller 357 and ECU communication unit 238.

The ECU WCE movement mechanism may be configured to push the ECU WCE against a pool structural element.

Any combination of any step of any one of the methods illustrated in the specification may be provided. Any combination of any feature of any claims may be provided. There may be provided a pool cleaning robot that is constructed and arranged to execute any combination of any steps of any of the methods illustrated in the specification. There may be provided a non-transitory computer readable medium that stores instructions for executing any combination of any steps of any of the methods illustrated in the specification.

“Configured” and “constructed and arranged” are used in an interchangeable manner.

The terms “comprising”, “including” having” “consisting”, and “consisting essentially of” are used in an interchangeable manner.

The phrase “may be” also cover “may not be”.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “rear” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Those skilled in the art will recognize that the boundaries between various components are merely illustrative and that alternative embodiments may merge various components or impose an alternate decomposition of functionality upon various components. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” Each other such that the desired functionality is achieved, irrespective of architectures or intermedial components. Likewise, any two components so associated can also be viewed as being “operably connected,” or “operably coupled,” to Each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for charging a pool related platform (PRP), the method comprises:
positioning a first wireless charging element (WCE) of the PRP within a charging range of a second WCE of a charging unit that is movable and is located at a temporary PRP location that is outside an interior of a pool structural element; wherein the positioning comprises moving the first WCE towards the PRP location; and
wirelessly charging, by the second WCE, the first WCE while maintaining the first WCE within the charging range of the second WCE.

2. The method according to claim 1, wherein the moving of the first WCE comprises moving the PRP towards the PRP location and moving the first WCE in relation to another part of the PRP.

3. The method according to claim 2, wherein the moving of the first WCE in relation to the other part comprises pushing the first WCE against an interior of the pool structural element.

4. The method according to claim 1 comprising moving the first WCE based on an indication of the temporary PRP location.

5. The method according to claim 4 wherein the indication of the temporary PRP location is wirelessly transmitted temporary PRP location information that provides an explicit indication of the PRP location.

6. The method according to claim 4 wherein the indication of the temporary PRP location is wirelessly transmitted radiation that is transmitted from the charging unit.

7. The method according to claim 1 wherein the positioning comprises aligning the first WCE with the second WCE.

8. The method according to claim 7 wherein the aligning is a sensor-based aligning that comprises using readings of one or more alignment sensors.

9. The method according to claim 1 comprising wirelessly communicating between the first WCE and the second WCE.

10. The method according to claim 1 comprising generating a status indication by the charging unit.

11. The method according to claim 1 wherein the charging unit is detachably coupled to the pool structural element during the wirelessly charging.

12. The method according to claim 1 wherein the charging unit is detachably coupled, by suction caps, to the pool structural element during the wirelessly charging.

13. The method according to claim 1 wherein the charging unit is detachably coupled, by hook & loop fasteners to the pool structural element during the wirelessly charging.

14. The method according to claim 1 wherein the charging unit is positioned within a holder element that is connected to the pool structural element during the wirelessly charging.

15. The method according to claim 1 wherein the second WCE is positioned, at least in part, within a stand-alone holder element.

16. The method according to claim 1 wherein the second WCE is positioned, at least in part, within a stand-alone holder element that comprises adjustable legs.

17. The method according to claim 1 comprising pushing the second WCE against the pool structural element.

18. The method according to claim 1 wherein the PRP is a pool cleaning robot.

19. A pool related platform (PRP) comprising:
a controller, a drive unit, a rechargeable battery, one or more sensors, and a charging module that comprises a first wireless charging element (WCE);
wherein the controller is configured to control the drive unit to move the PRP to maintain the first WCE within a charging range of a second WCE of a charging unit that is movable and is located at a temporary PRP location that is outside an interior of a pool structural element; and
wherein the first WCE is configured to be wirelessly charged, by the second WCE, while the first WCE is maintained within the charging range of the second WCE.

20. The PRP according to claim 19 comprising a first WCE movement mechanism that is configured to move the first WCE in relation to another part of the PRP.

21. The PRP according to claim 20 wherein the first WCE movement mechanism is configured to push the first WCE against an interior of the pool structural element.

22. The PRP according to claim 21 wherein the first WCE movement mechanism is configured to push the first WCE based on an indication of the temporary PRP location.

23. The PRP according to claim 20 wherein the first WCE movement mechanism is configured to align the first WCE with the second WCE.

24. The PRP according to claim 23 comprising one or more alignment sensors and wherein an alignment of the first WCE with the second WCE is a sensor-based alignment.

25. The PRP according to claim 20 wherein the controller is configured to control the drive unit to move towards the temporary PRP location based on an indication of the temporary PRP location

26. The PRP according to claim 25 wherein the indication of the temporary PRP location is wirelessly transmitted temporary PRP location information that provides an explicit indication of the PRP location.

27. The PRP according to claim 25 wherein the indication of the temporary PRP location is wirelessly transmitted radiation that is transmitted from the charging unit.

28. The PRP according to claim 19 wherein the PRP comprises a communication module that is in communication with the first WCE, wherein the communication module is configured to communicate, via the first WCE, with the second WCE.

29. The PRP according to claim 19 wherein the first WCE faces a bottom of a housing of the PRP.

30. The PRP according to claim 19 wherein the first WCE is parallel to a sidewall of the PRP.

31. The PRP according to claim 19 wherein the first WCE extends outside a housing of the PRP.

32. A external charging unit (ECU), comprising an EUC mechanical interface, an ECU charging module that comprises an ECU wireless charging element (WCE), an ECU housing and an ECU WCE movement mechanism that is configured to move the ECU WCE in relation to another part of the PRP.

33. The ECU according to claim 32 wherein the ECU WCE movement mechanism is configured to push the ECU WCE against a pool structural element.
